(19) United States
(12) Patent Application Publication
(10) Pub. No.: US 2011/0254318 A1
(43) Pub. Date: Oct. 20, 2011

(54) VEHICLE PILLAR STRUCTURE

(75) Inventors: Freeman Thomas, Laguna Beach, CA (US); Gregory Hutting, Rancho Santa Margarita, CA (US); Jeffrey Nield, Corona Del Mar, CA (US); Tyler Blake, Rancho Santa Margarita, CA (US); Matthew Edwards, Laguna Beach, CA (US); William Chaterlea, Laguna Nigel, CA (US); Ronald Anderson, Newport Beach, CA (US); Andrei Markevich, Aliso Viejo, CA (US)

(73) Assignee: FORD GLOBAL TECHNOLOGIES, LLC, Dearborn, MI (US)

(21) Appl. No.: 12/763,603

(22) Filed: Apr. 20, 2010

(51) Int. Cl. B62D 25/04; B60J 1/02; B62D 25/10; B60R 13/02

(52) U.S. Cl. 296/193.06; 296/214; 296/200; 296/210

(57) ABSTRACT

A vehicle pillar structure is provided with a pair of front pillars for extending upward and rearward from a vehicle body. A pair of rails extend rearward from the pair of front pillars. A pair of rear pillars extend downward and rearward from the pair of rails to the vehicle body. The pair of rear pillars each have a clearance aperture formed therethrough.

### BACKGROUND

Passenger vehicles have passenger compartments defined by a plurality of pillars extending from the body that converge at a roof with doors and windows oriented between adjacent pillars. The pillars are often formed integrally into the structure of the vehicle body. The pillars are commonly named from front to rear in alphabetical order. Thus, the pillars on either side of the windshield are referred to as A-pillars. The next sequential pillars are referred to as B-pillars, which are typically located on either side of a first set of doors. The next sequential pillars are often referred to as C-pillars, which are typically located on either side of a backlight for a two-door vehicle or are typically located on either side of a second set of doors for a sedan or other multiple-seating row vehicle.

Pillars that are oriented within the passenger compartment region typically extend from a side member to a roof frame. These pillars provide structural support to the passenger compartment from the side member to the roof frame. These passenger compartment pillars typically cooperate with an associated door and/or window.

In vehicles having multiple rows of seats, the B-pillar is commonly provided relatively centrally disposed with respect to the passenger compartment. A front door is often provided forward of the B-pillar. The B-pillar often creates a blind spot for the driver when peering over his shoulder. The B-pillar often creates a blind spot for other passengers within the vehicle. The C-pillar often creates a blind spot for the driver when looking through the backlight and rear side windows.

### SUMMARY

At least one embodiment provides a vehicle pillar structure with a pair of front pillars for extending upward and rearward from a vehicle body. A pair of rails extend rearward from the pair of front pillars. A pair of rear pillars extend downward and rearward from the pair of rails to the vehicle body. The pair of rear pillars each have a clearance aperture formed therethrough.

A further embodiment provides a rear window mounted to and extending across the pair of rear pillars for providing a view between the pair of rear pillars for passengers within the passenger compartment of the vehicle body. The clearance apertures of the pair of rear pillars are oriented to provide a view through the pair of rear pillars for the passengers.

An even further embodiment provides a rear header extending across the pair of rails adjacent to the pair of rear pillars, or extending across the pair of rear pillars adjacent the pair of rails so that the pair or rear pillars and the rear header collectively support the rear window.

Another further embodiment provides a plurality of cross members within the clearance aperture of each rear pillar for providing structural support to the rear pillar.

An even further embodiment orients the cross members with a thickness of each cross member facing a viewing direction to minimize obstructing the view through the rear pillar.

Yet another further embodiment provides the cross member at an orientation with a length of each cross member parallel to a viewing direction to minimize obstructing the view through the rear pillar.

Another further embodiment orients the cross members to separate each clearance aperture into a plurality of apertures each having a profile that is generally shaped as a trapezoid.

A further embodiment integrates each front pillar, corresponding rail, and corresponding rear pillar with a generally uniform curvature.

Another further embodiment provides a front header extending across the pair of rails adjacent the pair of front pillars, or extending across the pair of front pillars adjacent the pair of rails. A windshield is supported by the pair of front pillars and the front headers.

An even further embodiment provides a rear header extending across the pair of rails adjacent the pair of rear pillars, or extending across the pair of rear pillars adjacent the pair of rails. A roof is supported upon the pair of rails, the front header and the rear header.

An even further embodiment provides a headliner mounted to the interior to an interior side of the roof.

An even further embodiment removably affixes the roof to the pair of rails, the front header and the rear header. The headliner is removably affixed to the roof for providing interchangeability of the roof and the headliner for customization.

Another further embodiment provides a pair of intermediate pillars each extending from one of the rails towards the vehicle body. Each intermediate pillar is offset laterally inboard from an adjacent side window of the vehicle body for providing a view between the intermediate pillar and the window.

An even further embodiment provides a pair of safety restraint devices that are each mounted to one of the intermediate pillars.

Another further embodiment provides a vehicle with a two-door vehicle body having a pair of rear quarter panels each oriented rearward and adjacent to a door opening. The vehicle pillar structure is mounted to the vehicle body. A pair of rear side windows are each mounted to the vehicle body for extending to a closed position in contact with the pair of rails and spaced laterally outboard from the corresponding intermediate pillar, and for retracting into one of the pair of rear quarter panels in an open position.

Another embodiment provides a vehicle pillar structure with a pair of front pillars for extending upward and rearward from a vehicle body. A pair of rails extend rearward from the pair of front pillars. A pair of intermediate pillars each extend from the rails towards the vehicle body. Each intermediate pillar is offset laterally inboard from an adjacent side window of the vehicle body.

A further embodiment provides each intermediate pillar offset from the side window for providing a view between the intermediate pillar and the window.

Another further embodiment provides a pair of safety restraint devices each mounted to one of the intermediate pillars.

Another further embodiment provides a vehicle with a two-door vehicle body having a pair of rear quarter panels each oriented rearward and adjacent to a door opening. The vehicle pillar structure is mounted to the vehicle body. A pair of rear side windows are each mounted to the vehicle body for extending to a closed position in contact with the pair of rails and spaced laterally outboard from the corresponding intermediate pillar, and for retracting into one of the pair of rear quarter panels in an open position.

At least one embodiment provides a method for assembling a vehicle by providing a pillar structure with a series of pillars interconnected by a pair of rails. A front header is assembled onto the pillar structure. A rear header is assembled onto the pillar structure. A windshield is assembled onto the pillar structure. A rear window is assembled onto the pillar structure. A roof is assembled onto the pillar structure. After the front header, the rear header, the windshield, the rear window, the roof and the headliner are assembled onto the pillar structure, the pillar structure is assembled to the vehicle body.

### BRIEF DESCRIPTION OF THE DRAWINGS

FIG. 1 is a side perspective view of a passenger vehicle according to an embodiment;

FIG. 2 is a rear perspective view of the passenger vehicle of FIG. 1;

FIG. 3 is a top plan view of the passenger vehicle of FIG. 1;

FIG. 4 is a side perspective view of a pillar structure of the passenger vehicle of FIG. 1;

FIG. 5 is an enlarged partial rear perspective view of the pillar structure of FIG. 4;

FIG. 6 is a bottom perspective view of the pillar structure of FIG. 4;

FIG. 7 is an exploded perspective view of the pillar structure of FIG. 4;

FIG. 8 is a side perspective view of an interior of a passenger compartment of the passenger vehicle of FIG. 1;

FIG. 9 is an enlarged bottom perspective view of a portion of the interior of FIG. 8; and

FIG. 10 is a cross section through section line 10-10 in FIG. 8.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

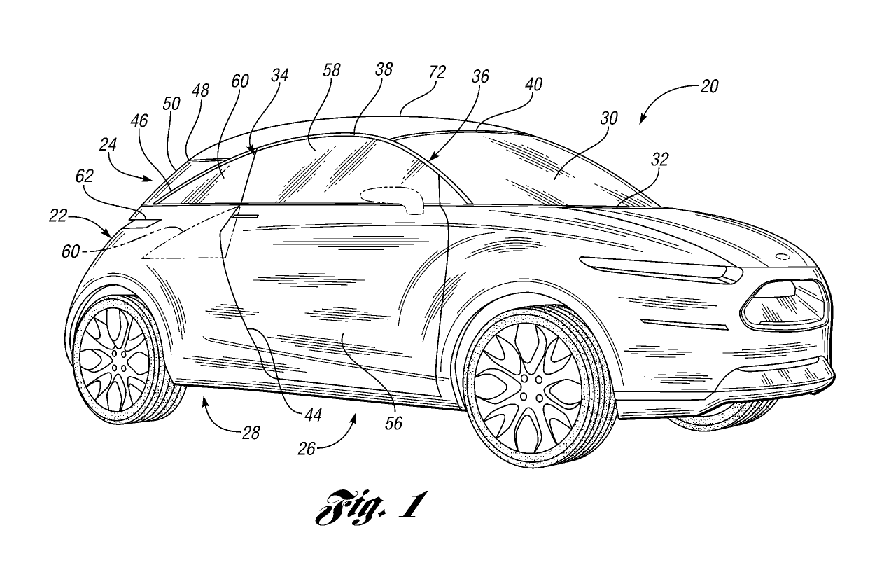

With reference now to FIGS. 1-3, a passenger vehicle is illustrated according to an embodiment and is referenced generally by numeral 20. Although the vehicle 20 is illustrated as a two-door passenger vehicle, the invention contemplates that the present invention may be employed with any passenger vehicle that employs a pillar structure.

The passenger vehicle 20 has a vehicle body 22, which provides the body structure for the vehicle 20. The vehicle body 22 defines a passenger compartment 24 for housing passengers within the vehicle 20. The passenger compartment 24 is provided with a front seating row 26 and a rear seating row 28 for transporting multiple rows of passengers.

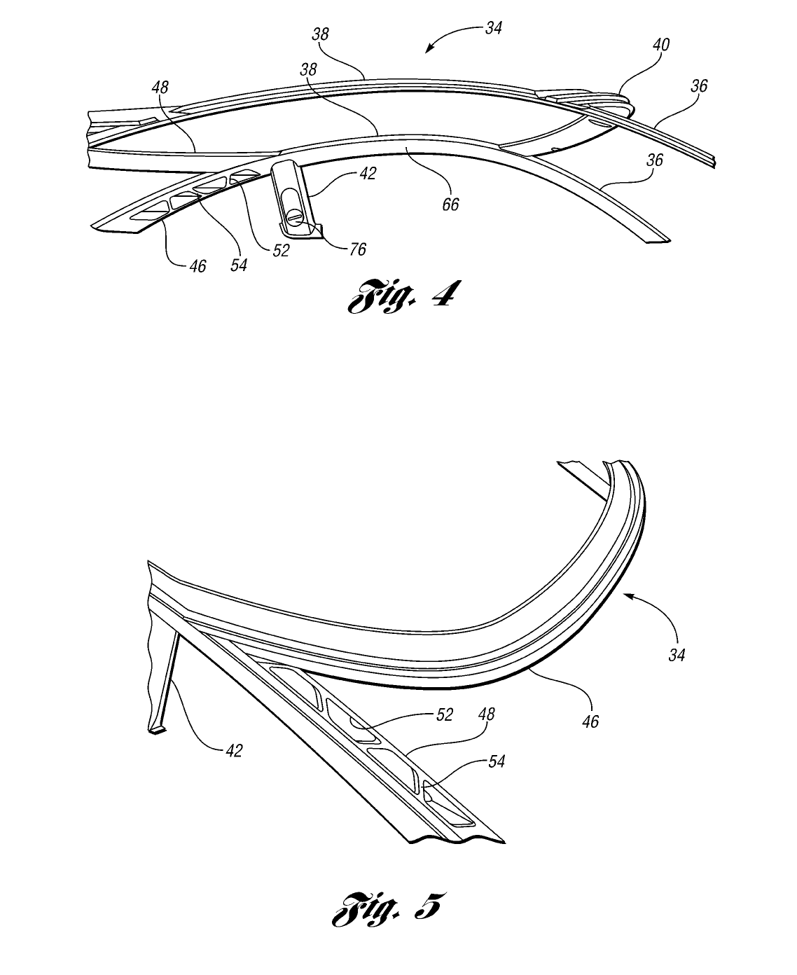

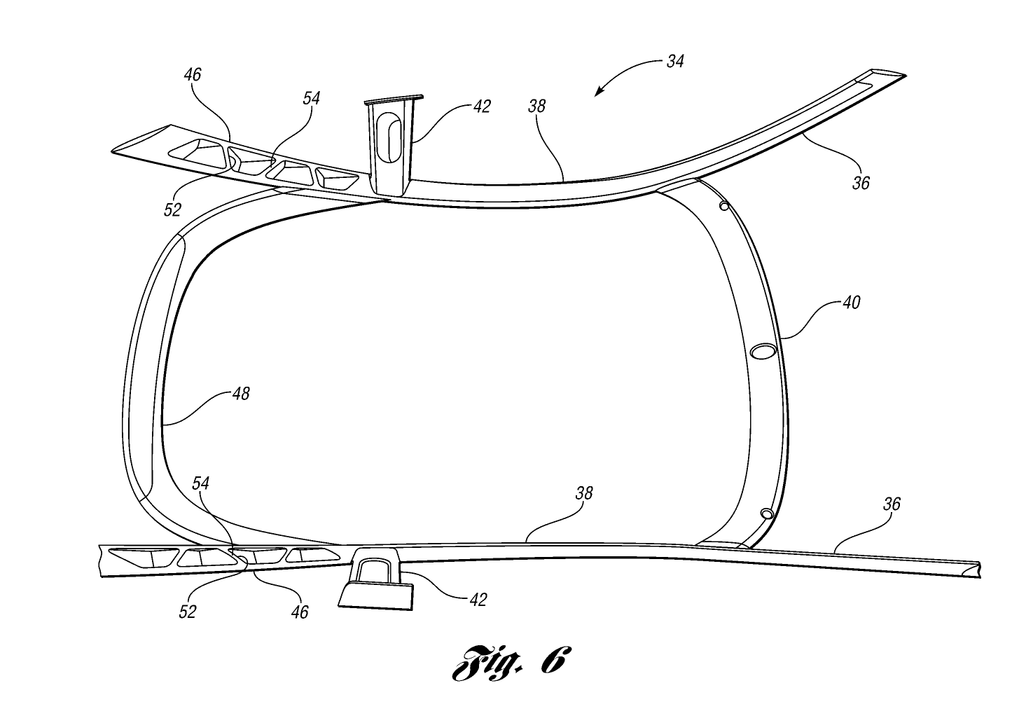

A forward region of the passenger compartment 24 is bounded by a windshield 30. The windshield 30 is supported by a cross-member 32 of the vehicle body 22 that extends beneath the windshield 30. The windshield 30 is supported on lateral sides thereof by a pillar structure 34, which is illustrated in FIGS. 4-9. The pillar structure 34 includes a pair of A-pillars 36 that extend upward and rearward from the cross-member 32 to a pair of rails 38.

A front header 40 is provided on the pillar structure 34 at the tops of the A-pillars 36, and at the end of the rails 38 for supporting the windshield 30. A pair of B-pillars 42 are each provided at the end of each of the rails 38 for extending downward to the vehicle body 22 for supporting the rails 38. The B-pillars 42 may be provided rearward of a door opening 44 (FIGS. 1-3) for structurally supporting the door opening 44 while permitting ingress and egress through the door opening 44.

A pair of C-pillars 46 are each provided on the pillar structure 44 extending from rear ends of the rails 38 down to the vehicle body 22. A rear header 48 is provided on the pillar structure 34 extending across the rear ends of the rails 38. The rear header 48 and the pair of seat pillars 46 collectively support a backlight 50.

Often, C-pillars may obstruct the view to the backlight 50. In order to broaden a view range through the backlight 50, a plurality of clearance apertures 52 are formed through the C-pillars 46. The clearance apertures permit the passengers to view through the C-pillars 46 as well as within a conventional range between the pair of C-pillars 46. The clearance apertures 52 are viewable in FIGS. 4 and 5. The C-pillars 46 include a plurality of cross-members 54 provided within the clearance apertures 52 for structurally enhancing the C-pillars 46. The cross-members 54 are generally planar and are oriented with the smallest dimension, a thickness, facing a viewing direction to minimize obstructing a view through the C-pillars 46. Thus, a length of the cross-members 54 is oriented parallel to the viewing direction to minimize obstructing the view through the C-pillars 46. The cross-members 54 are staggered angularly to separate each clearance aperture 52 into a series of trapezoid shaped apertures 52.

Referring again to FIGS. 1 to 3, the vehicle 20 has a pair of doors 56 each for enclosing one of the door openings 44. Each of the doors 56 includes a side window 58 for permitting side viewing from the passenger compartment 24. The side windows 58 are illustrated in an extended view whereby the side windows 58 engage the A-pillars 36 and the rails 38. In a retracted position, the side windows 58 are lowered within a panel of the door 56.

A pair of rear side windows 60 are also provided each extending from a rear quarter panel 62 of the vehicle body 22. Unlike static rear side windows of the prior art, the rear side windows 60 are retractable. The rear side windows 60 are illustrated in the extended position in solid whereby they engage the C-pillars 46 and the side windows 58. The rear side window 60 is also illustrated in phantom in the retracted position whereby the window 60 can drop into the rear quarter panel 62. The front and rear side windows 58, 60 collectively provide a side viewing range from the passenger compartment 24.

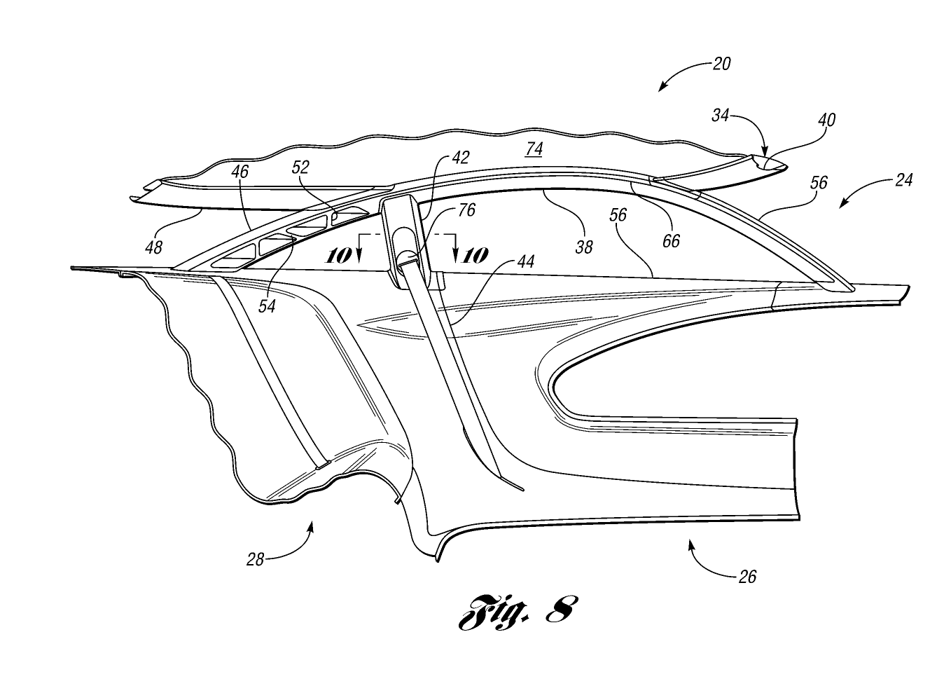

Referring now to FIG. 8, the B-pillar 42 is oriented within a side viewing range from the passenger compartment 24. In order to minimize the obstruction of the side view by the B-pillar 42, the B-pillars 42 are offset laterally inboard from the side windows 58, 60. As illustrated in FIG. 10, there is a space between the windows 58, 60 and the B-pillar 42. In prior art pillar structures, seals for the side windows are typically provided on the B-pillar. As illustrated in FIG. 10, a seal 64 is provided on the rear side windows 60 for meeting with the front side window 58 for providing a seal between the windows 58, 60 in the closed position of the windows 58, 60.

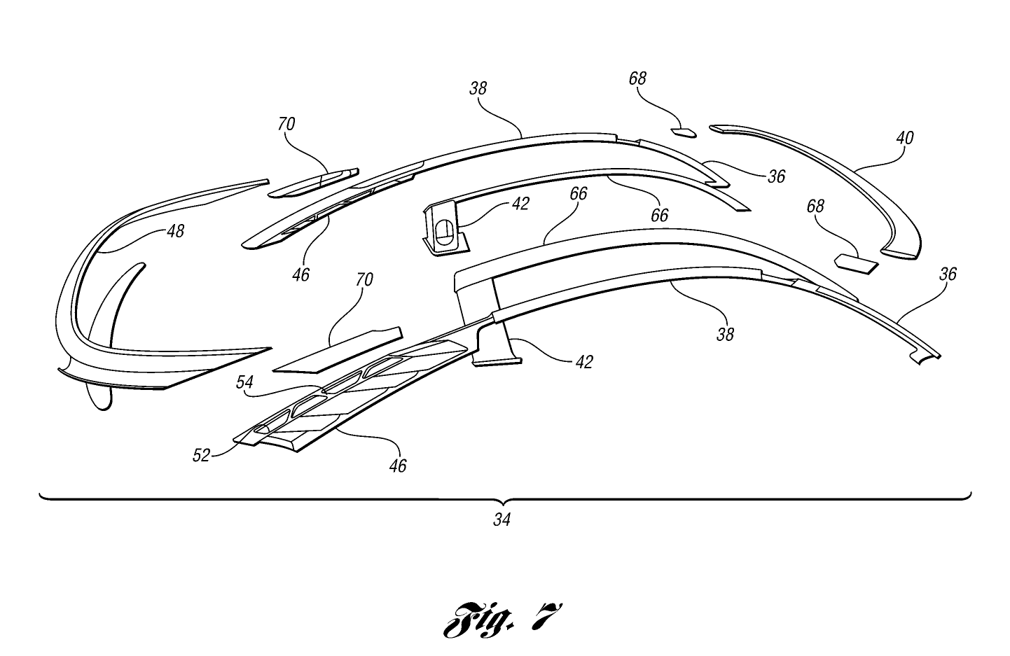

Referring again to FIG. 7, each A-pillar 36, rail 38, and C-pillar 46 may be formed integrally to have a generally uniform curvature. The B-pillars 42 and associated interior trim panels 66 are affixed to the rails 38. The headers 40, 48 may employ joint nodes 68, 70 for structural enhancement of the corresponding pillars 36, 46, rails 38, and headers 40, 48. The various components are made from either steel or aluminum for a balance of structural integrity and lightweight for optimizing the strength and efficiency of the vehicle 20.

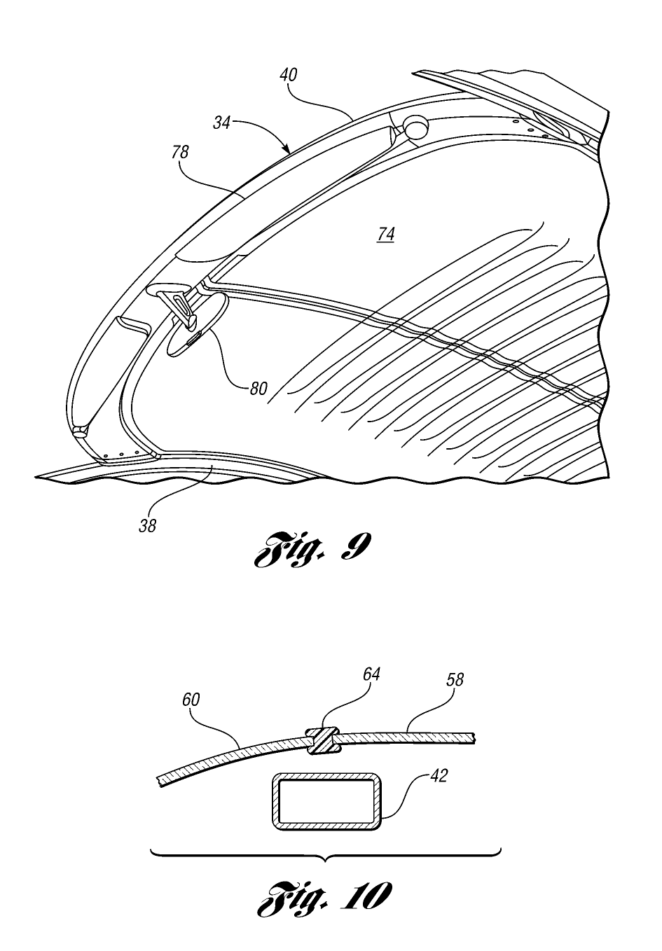

Referring again to FIGS. 1-3, a roof panel 72 is removably fastened to the rails 38 and headers 40, 48. Referring now to FIGS. 8 and 9, a headliner 74 is also removably fastened to the rails 38 and headers 40, 48. The removable attachment of the roof panel 72 and headliner 74 permit interchangeability of these components for customization in color and style for the vehicle. With continued reference to FIGS. 8 and 9, the pillar structure 34 can be provided with a safety restraint device 76 in the B-pillars 42. Additionally, sun visors 78 and a rearview mirror 80 can be provided on the front header 40.

The pillar structure 34 may be preassembled as a modular cassette prior to assembly to the vehicle body 22. Thus, the vehicle body 22 can be a monocoque structure for efficiency in design, customization, manufacturing, and fuel efficiency, which permits assembly of any of a variety of preassembled pillar structures 34.

The offset B-pillars 42, and the open C-pillars 46 provide an appearance of continuous glass, or greenhouse, from the exterior of the vehicle 20. Such styling creates a visual effect of a pillarless coupe.

The skeletal aluminum/steel hybrid structure 34 provides adequate strength to the roof 72, windshield 30 and backlight 50, while also providing support for the side windows 58, 60 of the vehicle 20. Additionally, side airbags may be provided in the A and B-pillars 36, 42. The headliner 74 may have snap-fit fastener as may other components within the vehicle 20, such as trim components, windshield panel, seat panels, and the like for permitting coordinated customization of various interior, and/or exterior panels (such as the roof panel 72) of the vehicle 20.

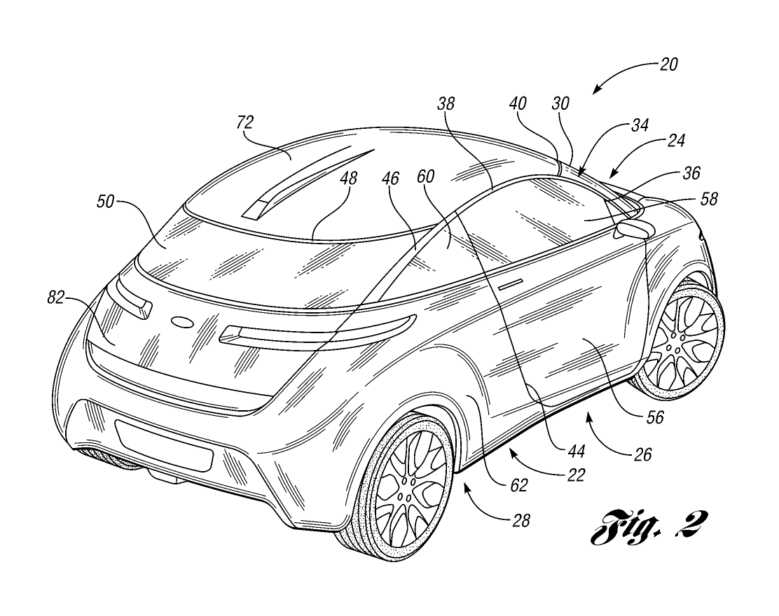

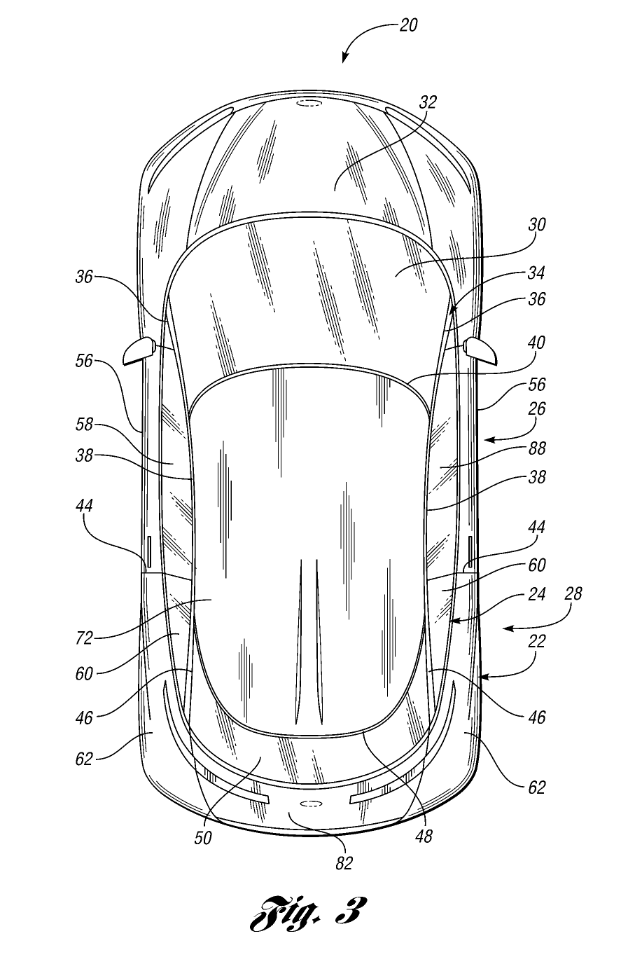

With reference again to FIGS. 2 and 3, the pillar structure 34 permits an enlarged backlight 50, which extends about the C-pillars 46. A trunk 82 may provided in the vehicle body 22 to separate a cargo compartment from the passenger compartment 24.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle pillar structure comprising:
a pair of front pillars for extending upward and rearward from a vehicle body;
a pair of rails extending rearward from the pair of front pillars; and
a pair of rear pillars extending downward and rearward from the pair of rails to the vehicle body, the pair of rear pillars each having a clearance aperture formed therethrough.

2. The vehicle pillar structure of claim 1 further comprising a rear window mounted to and extending across the pair of rear pillars for providing a view between the pair of rear pillars for passengers within a passenger compartment of the vehicle body, wherein the clearance apertures of the pair of rear pillars are oriented to provide a view through the pair of rear pillars for the passengers.

3. The vehicle pillar structure of claim 2 further comprising a rear header extending across the pair of rails adjacent the pair of rear pillars or extending across the pair of rear pillars adjacent the pair of rails so that the pair of rear pillars and the rear header collectively support the rear window.

4. The vehicle pillar structure of claim 1 wherein each of the pair of rear pillars comprises a plurality of cross members provided within the clearance aperture for providing structural support to the rear pillar.

5. The vehicle pillar structure of claim 4 wherein the cross members are each oriented with a thickness of the cross member facing a viewing direction to minimize obstructing the view through the rear pillar.

6. The vehicle pillar structure of claim 4 wherein the cross members are each oriented with a length of the cross member parallel to a viewing direction to minimize obstructing the view through the rear pillar.

7. The vehicle pillar structure of claim 4 wherein the cross members are each oriented to separate each clearance aperture into a plurality of apertures each having a profile that is generally shaped as a trapezoid.

8. The vehicle pillar structure of claim 1 wherein each front pillar, corresponding rail, and corresponding rear pillar are integrated with a generally uniform curvature.

9. The vehicle pillar structure of claim 1 further comprising a front header extending across the pair of rails adjacent the pair of front pillars or extending across the pair of front pillars adjacent the pair of rails; and
a windshield supported by the pair of front pillars and the front header.

10. The vehicle pillar structure of claim 9 further comprising:
a rear header extending across the pair of rails adjacent the pair of rear pillars or extending across the pair of rear pillars adjacent the pair of rails; and
a roof supported upon the pair of rails, the front header and the rear header.

11. The vehicle pillar structure of claim 10 further comprising a headliner mounted to an interior side of the roof.

12. The vehicle pillar structure of claim 11 wherein the roof is removably affixed to the pair of rails, the front header and the rear header and the headliner is removably affixed to the roof for providing interchangeability of the roof and the headliner for customization.

13. The vehicle pillar structure of claim 1 further comprising a pair of intermediate pillars each extending from one of the rails towards the vehicle body, each intermediate pillar being offset laterally inboard from an adjacent side window of the vehicle body for providing a view between the intermediate pillar and the window.

14. The vehicle pillar structure of claim 13 further comprising a pair of safety restraint devices each mounted to one of the intermediate pillars.

15. A vehicle comprising:
a two-door vehicle body having a pair of rear quarter panels each oriented rearward and adjacent to a door opening;
a vehicle pillar structure according to claim 13 mounted to the vehicle body; and
a pair of rear side windows each mounted to the vehicle body for extending to a closed position in contact with the pair of rails and spaced laterally outboard from the corresponding intermediate pillar, and for retracting into one of the pair of rear quarter panels in an open position.

16. A vehicle pillar structure comprising:
a pair of front pillars for extending upward and rearward from a vehicle body;
a pair of rails extending rearward from the pair of front pillars;
a pair of intermediate pillars each extending from the rails towards the vehicle body, each being offset laterally inboard from an adjacent side window of the vehicle body; and
a roof supported upon the pair of front pillars, the pair of rails, and the pair of intermediate pillars.

17. The vehicle pillar structure of claim 16 wherein each intermediate pillar is offset from the side window for providing a view between the intermediate pillar and the window.

18. The vehicle pillar structure of claim 16 further comprising a pair of safety restraint devices each mounted to one of the intermediate pillars.

19. A vehicle comprising:
a two-door vehicle body having a pair of rear quarter panels each oriented rearward and adjacent to a door opening;
a vehicle pillar structure according to claim 16 mounted to the vehicle body; and
a pair of rear side windows each mounted to the vehicle body for extending to a closed position in contact with the pair of rails and spaced laterally outboard from the corresponding intermediate pillar, and for retracting into one of the pair of rear quarter panels in an open position.

20. A method for assembling a vehicle comprising:
providing a pillar structure with a series of pillars interconnected by a pair of rails;
assembling a front header onto the pillar structure;
assembling a rear header onto the pillar structure;
assembling a windshield onto the pillar structure;
assembling a rear window onto the pillar structure;
assembling a roof onto the pillar structure;
assembling a headliner onto the pillar structure; and
after the front header, the rear header, the windshield, the rear window, the roof and the headliner are assembled onto the pillar structure, assembling the pillar structure to a vehicle body.
